(19) United States
(12) Patent Application Publication
(10) Pub. No.: US 2017/0109844 A1
(43) Pub. Date: Apr. 20, 2017

(54) METHOD AND SYSTEM FOR CUSTOMIZING POINT OF SALE ITEM SELECTION LISTING

(71) Applicant: MasterCard International Incorporated, Purchase, NY (US)

(72) Inventor: David Colby BROWN, Dardenne Prairie, MO (US)

(73) Assignee: MasterCard International Incorporated, Purchase, NY (US)

(21) Appl. No.: 15/298,754

(22) Filed: Oct. 20, 2016

Related U.S. Application Data
(60) Provisional application No. 62/243,974, filed on Oct. 20, 2015.

(51) Int. Cl. G06Q 50/12; G06Q 20/20; G06Q 30/06

(52) U.S. Cl. CPC G06Q 50/12; G06Q 30/0621; G06Q 30/0635; G06Q 20/20

(57) ABSTRACT

A method for submitting preselected, customized data exchanged between a mobile device and a point of sale includes: establishing, by a communication module of a point of sale device, a communication connection between the point of sale device and a mobile computing device in geographic proximity to the point of sale device; receiving, by a receiving device of the point of sale device, a data signal electronically transmitted by the mobile computing device via the communication connection, wherein the data signal is superimposed with at least one custom item identifier; identifying, by a data identification module of the point of sale device, one or more preselected, customized menu options based on at least the at least one custom item identifier; and submitting, to an order processing module of the point of sale device, the identified one or more preselected, customized menu options.

### FIELD

The present disclosure relates to the customizing of an item selection listing in a point of sale, specifically the use of a communication connection between a point of sale and a mobile device to exchange preselected, customized menu item selections from the mobile device.

### BACKGROUND

At merchants where consumers place orders, the merchants often attempt to make the ordering process as simple and efficient as possible for consumers. For example, many fast food restaurants list combination orders in their menus, so that the consumer can order multiple items at once via the combination, to save time and make the menu selection easier for the consumer and for the merchant's employee at the point of sale. In addition, such orders often times have a number or other identifier associated with them for even faster identification and selection.

However, in many instances, even the most detailed menu selections may require further clarification and modification by a consumer. For instance, a combination order at a restaurant may include an entrée, side, and a drink, but the consumer may be required to provide what drink they want, which can require additional entries in the point of sale, and thus take additional time and also be susceptible to error, resulting in an incorrect order and endangering customer retention. In many cases, consumers may also desire to further customize their order, such as by modifying their entrée, substituting a side, specifying details about their drink, etc. In these instances, each customization involves one or more additional submissions to be made by the employee of the merchant at the point of sale, with each additional submission taking additional time and being susceptible to error.

Thus, there is a need for a technical solution whereby a consumer can establish customized, preselected menu options that can be displayed to an employee at the point of sale, where selection of one of the customized menu options will submit the preselected order for fulfillment in the point of sale system. As a result, a consumer and employee can ensure that a customized order is properly entered and fulfilled quickly and efficiently, without the need for additional data entry or communication by either party, cutting down on the opportunity for miscommunication and entry error.

### SUMMARY

The present disclosure provides a description of systems and methods for submitting preselected, customized data exchanged between a mobile device and a point of sale.

A method for submitting preselected, customized data exchanged between a mobile device and a point of sale includes: establishing, by a communication module of a point of sale device, a communication connection between the point of sale device and a mobile computing device in geographic proximity to the point of sale device; receiving, by a receiving device of the point of sale device, a data signal electronically transmitted by the mobile computing device via the communication connection, wherein the data signal is superimposed with at least one custom item identifier; identifying, by a data identification module of the point of sale device, one or more preselected, customized menu options based on at least the at least one custom item identifier; and submitting, to an order processing module of the point of sale device, the identified one or more preselected, customized menu options.

A system for submitting preselected, customized data exchanged between a mobile device and a point of sale includes: a communication module of a point of sale device configured to establish a communication connection between the point of sale device and a mobile computing device in geographic proximity to the point of sale device; a receiving device of the point of sale device configured to receive a data signal electronically transmitted by the mobile computing device via the communication connection, wherein the data signal is superimposed with at least one custom item identifier; a data identification module of the point of sale device configured to identify one or more preselected, customized menu options based on at least the at least one custom item identifier; and an order processing module of the point of sale device configured to receive a submission of the identified one or more preselected, customized menu options.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for exchanging preselected, customized menu options and selections between a mobile device and a point of sale in accordance with exemplary embodiments.

FIG. 2 is a block diagram illustrating the point of sale device of FIG. 1 for the storage and submission of preselected, customized menu options in accordance with exemplary embodiments.

FIG. 3 is a flow diagram illustrating a process for registering preselected, customized menu options in a point of sale device using a mobile device in accordance with exemplary embodiments.

FIG. 4 is a flow diagram illustrating a process for sharing preselected, customized menu options with a point of sale device and selection thereof in accordance with exemplary embodiments.

FIG. 5 is a flow chart illustrating an exemplary method for submitting preselected, customized data exchanged between a mobile device and a point of sale in accordance with exemplary embodiments.

FIG. 6 is a flow diagram illustrating the processing of a payment transaction in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

### System for Exchanging Preselected, Customized Menu Options

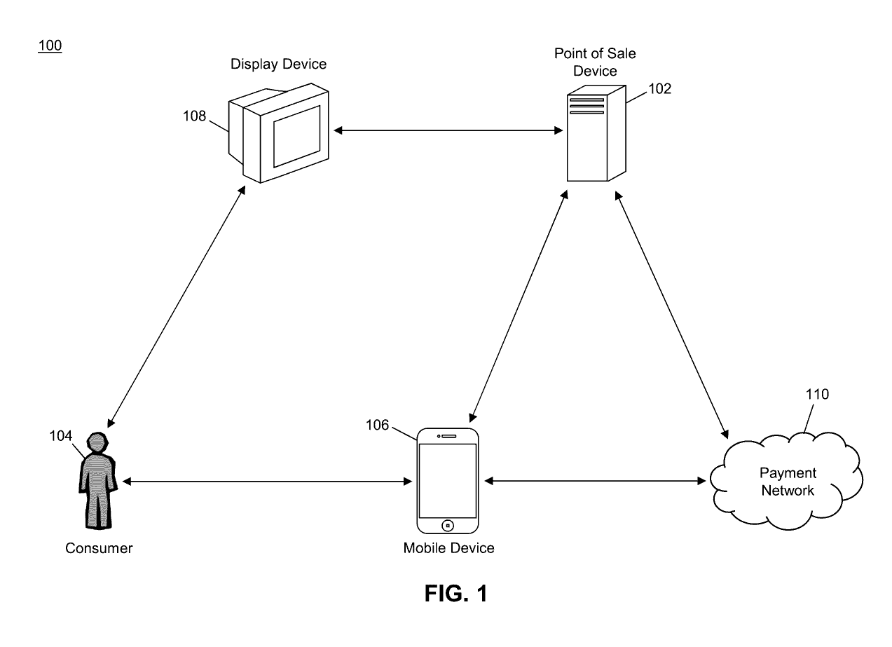

FIG. 1 illustrates a system 100 for the registration and selection of preselected, customized menu options at a point of sale device via a mobile device.

The system 100 may include a point of sale device 102. The point of sale device 102, discussed in more detail below, may be configured to receive one or more preselected, customized menu options and enable the selection of a preselected, customized menu option for fulfillment. The point of sale device 102 may be any suitable type of computing device configured to operate as a point of sale and specifically configured to perform the functions discussed herein. The point of sale device 102 may be, for example, a desktop computer, tablet computer, smart phone, notebook computer, etc. configured to display menu options to a user and configured to, as discussed below, receive preselected, customized menu options for selection.

In the system 100, a consumer 104 may register one or more preselected, customized menu options via a mobile device 106. The mobile device 106 may be configured to execute an application program configured to enable the consumer 104 to register one or more preselected, customized menu options. The mobile device 106 may be any mobile computing device suitable for performing the functions discussed herein, such as a cellular phone, smart phone, tablet computer, laptop computer, wearable computing device, implantable computing device, etc. Each preselected, customized menu option may include one or more associated menu items, whereby selection of the preselected, customized menu option at the point of sale device 102 may initiate submission of the one or more associated menu items in the point of sale device 102 for fulfillment. For example, the consumer 104 may register a menu option comprising a burger value meal, with cheese added, no onions, medium sized, and an iced tea. The preselected, customized menu option may thus be associated with each of the corresponding menu items.

The consumer 104 may visit a merchant location with their mobile device 106 to take advantage of the preselected, customized order option. When the mobile device 106 is in geographic proximity to the point of sale device 102, a communication connection may be established between the point of sale device 102 and the mobile device 106. The communication connection may be a secure connection and may utilize radio frequency, near field communication, Bluetooth, or other suitable communication method. In some embodiments, the secure communication connection may be manually initiated by the consumer 104 using the mobile device 106 or by a user of the point of sale device 102. In other embodiments, the point of sale device 102 and mobile device 106 may automatically establish the secure communication connection upon reaching a geographic proximity in which the devices may detect and connect with one another using the appropriate protocol. For instance, when the mobile device 106 and point of sale device 102 detect each other using Bluetooth, the two devices may automatically establish the secure communication connection.

Once the connection is established, the mobile device 106 may electronically transmit a data signal using the secured connection to the point of sale device 102. The data signal may be superimposed with each of the preselected, customized menu options registered in the mobile device 106 by the consumer 104. Each preselected, customized menu option may be associated with a custom item identifier as well as one or more corresponding menu items. The custom item identifier may be an identification number, username, device identifier, e-mail address, phone number, or other suitable type of identifier used to identify the corresponding preselected, customized menu option. In some instances, the data signal may also be superimposed with a consumer identifier associated with the consumer 104 and their customized, preselected menu options as a whole. For example, the consumer 104 may have three preselected, customized menu options that are each associated with a corresponding identification number (e.g., 1, 2, or 3) as a custom item identifier, with a device identifier associated with the mobile device 106 (e.g., a media access control address, registration number, serial number, identification number, phone number, e-mail address, username, etc.) also superimposed in the data signal.

The point of sale device 102 may parse the received data signal to obtain the data superimposed therein and may display, to a user of the point of sale device 102, each of the preselected, customized menu options for selection. In some instances, each preselected, customized menu option may be associated with additional data, such as a title, image, description, etc. For example, the consumer 104 may register a first preselected, customized menu option that they may title “John's Meal.” The point of sale device 102 may thus display “John's Meal,” which may represent the associated menu items registered for the meal by the consumer 104.

Once the preselected, customized menu options have been conveyed to the point of sale device 102, the consumer 104 may then convey their meal selection(s) to the user of the point of sale device 102. The selections may be conveyed to the user of the point of sale device 102 using traditional methods (e.g., verbal communication between the consumer 104 and user), or may be performed using the mobile device 106. For example, the consumer 104 may indicate a preselected, customized menu option using the mobile device 106, which may electronically transmit a data signal to the point of sale device 102 via the secure communication connection that is superimposed with the selection. In some instances, the indication may be included in the data signal used to send the preselected, customized menu options to the point of sale device 102. Once the user has received the consumer's selection, the user may select the corresponding menu items in the point of sale device 102 via a suitable input device, which may include the selection of one or more of the preselected, customized menu options. For example, if the consumer 104 registered “John's Meal” as a preselected, customized menu option representing a burger value meal with cheese, no onions, and an iced tea, the employee may select “John's Meal” from a display of the point of sale device 102, which may then add each of the associated menu items to the current order. Once the order is completed, the point of sale device 102 may then submit the order for fulfillment, such as by displaying the menu items on a ticket for preparation of the order by employees of the merchant.

The use of the preselected, customized menu options may enable the consumer 104 to place a personally customized order without the need to convey each of the customized menu items to the employee user of the point of sale device 102, which may increase efficiency, as well as decrease the likelihood of error in the order. For example, the consumer 104 may order their registered “John's Meal,” which may comprise the pressing of a single button on the point of sale device 102 for “John's Meal” by the employee, in place of the entry of a burger value meal, added cheese to the burger, holding of onions on the burger, and selection of an iced tea to drink, where each selection is susceptible to error in data entry and communication. In instances where the consumer 104 may be ordering several preselected, customized menu options (e.g., a special order for each member of a party), the susceptibility for error in traditional ordering, as well as the time necessary for entry of the order, may greatly increase. As a result, the methods and systems discussed herein enable more efficient and accurate entry of orders in the point of sale device 102 via the data exchanged between the point of sale device 102 and the mobile device 106.

In some embodiments, the point of sale device 102 may be configured to store the consumer's preselected, customized menu options. For example, the point of sale device 102 may receive the consumer's preselected, customized menu options during a registration process, or as part of an ordering process as discussed above, and may store the preselected, customized menu options in local data storage. In some instances, the storage of the preselected, customized menu options may include the generation of custom item identifiers for each menu option. The menu options may be stored with the associated menu items and the associated custom item identifier. When the secure communication connection is established between the point of sale device 102 and the mobile device 106, the data signal electronically transmitted by the mobile device 106 may include only the custom item identifiers (e.g., and a consumer identifier, if applicable). The point of sale device 102 may then identify the corresponding menu items in local storage upon selection of a preselected, customized menu option by the consumer 104 and entry thereof in the point of sale device 102 by the user.

In some instances, the menu items may be stored in external storage, such as by a third party data storage entity. In such instances, the point of sale device 102 may receive the custom item identifiers from the mobile device 106 via the secure communication connection, and may then electronically transmit a request to the third party data storage entity that includes the custom item identifiers (e.g., and consumer identifier, if applicable) via a suitable communication network. The third party data storage entity may identify the associated menu items, and may return the menu items via a data signal electronically transmitted back to the point of sale device 102 using the communication network. The point of sale device 102 may parse the received data signal to obtain the menu items for inclusion in an order upon selection of the corresponding menu option by the user of the point of sale device 102. In some instances, a request for menu items may be submitted to the third party data entry upon selection of a preselected, customized menu option by the user of the point of sale device 102.

In some embodiments, the system 100 may include a display device 108. The display device 108 may be any type of display device suitable for performing the functions discussed herein, such as a liquid crystal display, light-emitting diode display, thin film transistor display, touch screen display, etc. The display device 108 may be configured to be visible to the consumer 104 and display the preselected, customized menu options registered by the consumer 104. For example, when the point of sale device 102 identifies the preselected, customized menu options registered by the consumer 104 (e.g., from the data signal electronically transmitted by the mobile device 106 using the secure communication connection or identified in local or external data storage using custom item identifiers contained therein), the point of sale device 102 may electronically transmit the preselected, customized menu options to the display device 108. The display device 108 may then display data associated with the preselected, customized menu options, such as the custom item identifiers, descriptors registered by the consumer 104 (e.g., the “John's Meal” name), the associated menu items, etc. The display device 108 may thus assist the consumer 104 in the selection of their order via the display of their registered preselected, customized menu options.

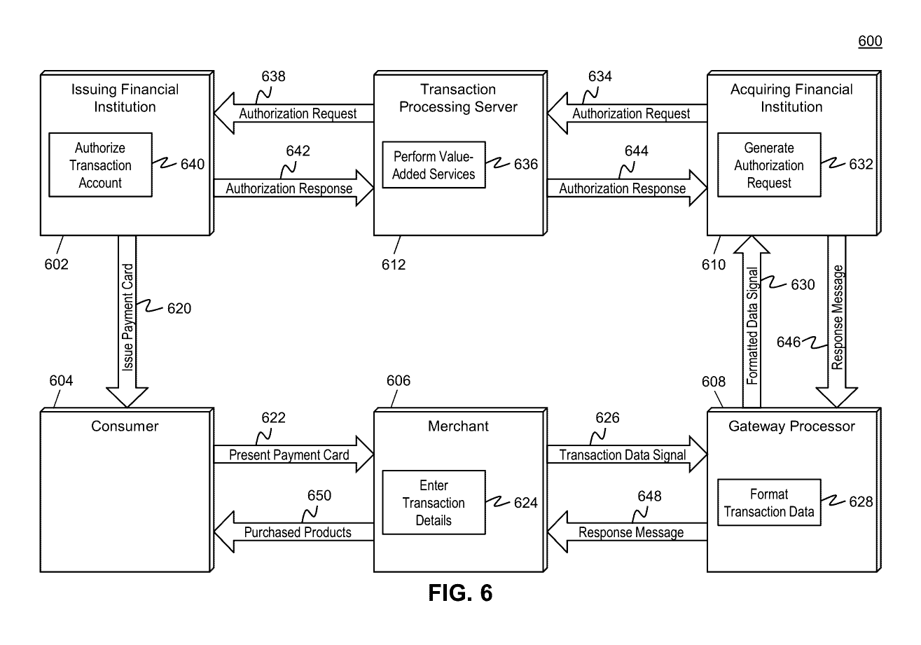

In some embodiments, the mobile device 106 and point of sale device 102 may be configured to exchange data for payment of the order being placed by the consumer 104. For example, the mobile device 106 may include a digital wallet application program configured to store payment credentials suitable for use in funding a payment transaction. The consumer 104 may inform the user of the point of sale device 102 of their order (e.g., via verbal communication, the mobile device 106, etc.), which may include one or more preselected, customized menu options, and then may inform the user that they wish to use their mobile device 106 for payment. The user of the point of sale device 102 may indicate an appropriate selection for the payment method for the transaction using the point of sale device 102. In some instances, the point of sale device 102 may electronically transmit a request for payment credentials to the mobile device 106 using the secure communication connection, which may be responded to by the mobile device 106 with the requested payment credentials. In other instances, the mobile device 106 may include the payment credentials in the data signal superimposed with the preselected, customized menu options. In such instances, when the user of the point of sale device 102 selects the appropriate payment method, the previously received payment credentials may be used. The point of sale device 102 may then submit the payment credentials in addition to other transaction data (e.g., a transaction amount) to one or more entities for forwarding on to a payment network 110 for processing. Methods and systems for processing payment transactions are discussed in more detail below with respect to the process 600 illustrated in FIG. 6. In some instances, the mobile device 106 may be configured to electronically transmit the payment credentials or other data to the payment network 110 for processing of the payment transaction.

### Point of Sale Device

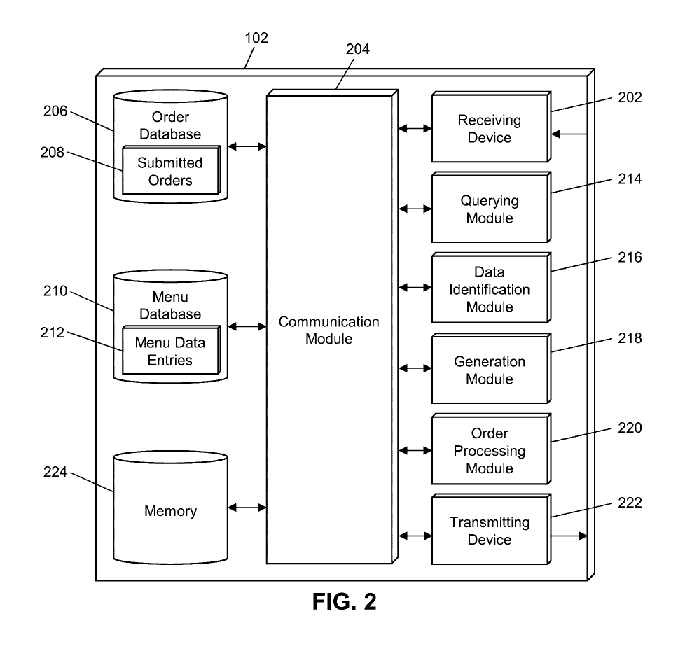

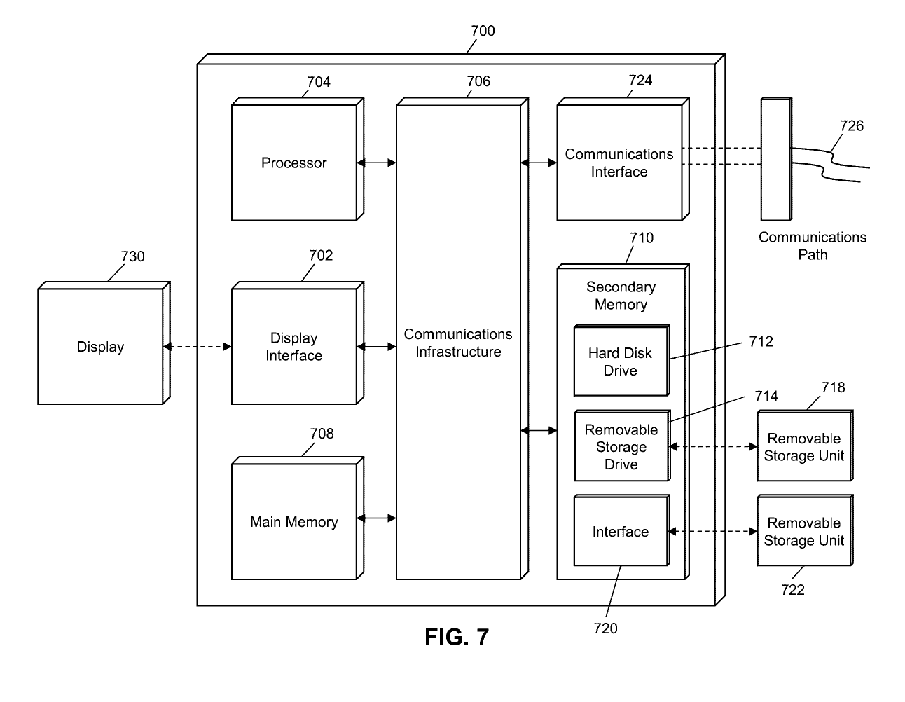

FIG. 2 illustrates an embodiment of the point of sale device 102 of the system 100. It will be apparent to persons having skill in the relevant art that the embodiment of the point of sale device 102 illustrated in FIG. 2 is provided as illustration only and may not be exhaustive to all possible configurations of the point of sale device 102 suitable for performing the functions as discussed herein. For example, the computer system 700 illustrated in FIG. 7 and discussed in more detail below may be a suitable configuration of the point of sale device 102.

The point of sale device 102 may include a receiving device 202. The receiving device 202 may be configured to receive data over one or more networks via one or more network protocols. In some embodiments, the receiving device 202 may be configured to receive data over the payment rails, such as using specially configured infrastructure associated with payment networks 110 for the transmission of transaction messages that include sensitive financial data and information. In some instances, the receiving device 202 may also be configured to receive data from mobile devices 106, display devices 108, payment networks 110, and other entities via alternative networks, such as the Internet. In some embodiments, the receiving device 202 may be comprised of multiple devices, such as different receiving devices for receiving data over different networks, such as a first receiving device for receiving data over payment rails and a second receiving device for receiving data over the Internet. The receiving device 202 may receive electronically data signals that are transmitted, where data may be superimposed on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by the mobile device 106 via the secure communication connection. The data signals may be superimposed with custom item identifiers for preselected, customized menu options and, in some instances, may also be superimposed with the associated menu items and descriptors. In some instances, the receiving device 202 may receive data signals from mobile devices 106 superimposed with payment credentials. The receiving device 202 may also be configured to receive data signals electronically transmitted by third party data storage entities, such as data signals superimposed with menu items corresponding to custom item identifiers.

The point of sale device 102 may also include a communication module 204. The communication module 204 may be configured to transmit data between modules, engines, databases, memories, and other components of the point of sale device 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the point of sale device 102 and external components of the point of sale device 102, such as externally connected databases, display devices, input devices, etc. The point of sale device 102 may also include a processing device. The processing device may be configured to perform the functions of the point of sale device 102 discussed herein as will be apparent to persons having skill in the relevant art. In some embodiments, the processing device may include and/or be comprised of a plurality of engines and/or modules specially configured to perform one or more functions of the processing device, such as a querying module 214, data identification module 216, generation module 218, order processing module 220, etc. As used herein, the term “module” may be software or hardware particularly programmed to receive an input, perform one or more processes using the input, and provide an output. The input, output, and processes performed by various modules will be apparent to one skilled in the art based upon the present disclosure.

In some embodiments, the point of sale device 102 may include an order database 206. The order database 206 may be configured to store a plurality of submitted orders 208 using a suitable data storage format and schema. The order database 206 may be a relational database that utilizes structured query language for the storage, identification, modifying, updating, accessing, etc. of structured data sets stored therein. Each submitted order 208 may be a structured data set configured to store data associated with an order placed by a consumer 104 to be fulfilled by the associated merchant. Each submitted order 208 may include, for example, one or more menu items as entered into the point of sale device 102 by a user and submitted thereby for fulfillment.

In some embodiments, the point of sale device 102 may include a menu database 210. The menu database 210 may be configured to store a plurality of menu data entries 212 using a suitable data storage format and schema. The menu database 210 may be a relational database that utilizes structured query language for the storage, identification, modification, updating, accessing, etc. of structured data sets stored therein. Each menu data entry 212 may be a structured data set configured to store data associated with a preselected, customized menu option. Each menu data entry 212 may include a custom item identifier and one or more associated menu items, and may also include a consumer identifier and one or more descriptors associated with the preselected, customized menu option.

The point of sale device 102 may include a querying module 214. The querying module 214 may be configured to execute queries on databases to identify information. The querying module 214 may receive one or more data values or query strings, and may execute a query string based thereon on an indicated database, such as the order database 206, to identify, update, modify, or otherwise manage information stored therein. The querying module 214 may output identified information or indications regarding performed operations to an appropriate engine or module of the point of sale device 102 as necessary. The querying module 214 may, for example, execute a query on the order database 206 to add a new submitted order 208 to the order database 206 upon completion of an order by a consumer 104. The querying module 214 may also, for example, execute queries on the order database 206 to delete submitted orders 208 upon fulfillment, or on the menu database 210 to add new menu data entries 212 that are registered or identify menu data entries 212 when an order is being placed.

The data identification module 216 may be configured to identify menu items for inclusion in an order based on custom item identifiers. In some instances, the data identification module 216 may identify menu items associated with a custom item identifier as parsed from a data signal electronically transmitted by the mobile device 106 using the secure communication connection that also include the custom item identifiers. In other instances, the data identification module 216 may instruct the querying module 214 to execute a query on the menu database 210 to identify menu data entries 212 corresponding to custom item identifiers identified from the data signal electronically transmitted by the mobile device 106 using the secure communication connection. In some cases, the data identification module 216 may instruct additional modules and engines of the point of sale device 102 to obtain menu items from an external data storage entity, such as a transmitting device 222 and the receiving device 202.

The generation module 218 may be configured to generate data messages and structured data sets for usage in performing the functions disclosed herein. The generation module 218 may be configured to generate new submitted orders 208 for adding to the order database 206 (e.g., via the querying module 214) upon completion of an order as indicated by a user of the point of sale device 102. The generation module 218 may also be configured to generate menu data entries 212, such as upon registration of a new preselected, customized menu option by a consumer 104. The generation module 218 may be further configured to generate data requests for electronic transmission to an external data storage entity that include one or more custom item identifiers for which associated menu items are requested.

The order processing module 220 may be configured to perform additional functions of the point of sale device 102 for performing payment transactions as discussed herein. For instance, the order processing module 220 may be configured to instruct the querying module 214 to add, modify, or delete submitted orders 208 based on instructions submitted to the point of sale device 102 (e.g., via the receiving device 202 or an input device). The order processing module 220 may also be configured to operate one or more displays and/or input devices of the point of sale device 102 for use in performing traditional functions associated with a point of sale, such as the input of menu items, calculation of transaction amounts, submission of transaction data to a financial institution, etc.

The transmitting device 222 may be configured to transmit data over one or more networks via one or more network protocols. In some embodiments, the transmitting device 222 may be configured to transmit data over the payment rails, such as using specially configured infrastructure associated with payment networks 110 for the transmission of transaction messages that include sensitive financial data and information, such as identified payment credentials. In some instances, the transmitting device 222 may be configured to transmit data to mobile devices 106, display devices 108, payment networks 110, external data storage entities, and other entities via alternative networks, such as the Internet. In some embodiments, the transmitting device 216 may be comprised of multiple devices, such as different transmitting devices for transmitting data over different networks, such as a first transmitting device for transmitting data over the payment rails and a second transmitting device for transmitting data over the Internet. The transmitting device 222 may electronically transmit data signals that have data superimposed that may be parsed by a receiving computing device. In some instances, the transmitting device 222 may include one or more modules for superimposing, encoding, or otherwise formatting data into data signals suitable for transmission.

The transmitting device 222 may be configured to electronically transmit data signals to display devices 108 that are superimposed with preselected, customized menu option data for display to a consumer 104. The transmitting device 222 may also be configured to electronically transmit data signals to external data storage entities that include requests for menu items, where the request includes at least a custom item identifier associated with each preselected, customized menu option for which menu items are requested. The transmitting device 222 may also be configured to electronically transmit transaction data to financial institutions for use in processing payment transactions, such as to merchants and/or gateway processors, as discussed in more detail below with respect to the process 600 illustrated in FIG. 6.

The point of sale device 102 may also be configured to establish a secure communication connection with the mobile device 106. The establishing of the secure communication connection with the mobile device 106 may involve at least the receiving device 202, transmitting device 222, and communication module 204 of the point of sale device 102 and may utilize one or more data exchanges between the point of sale device 102 and the mobile device 106 to establish the secure communication connection. Methods for the establishing of a secure communication connection will be apparent to persons having skill in the relevant art. The secure communication connection may be established such that data may be exchanged between the point of sale device 102 and mobile device 106 repeatedly using the same connection channel. In some embodiments, the point of sale device 102 may be configured to automatically establish the secure communication connection when the mobile device 106 is in a geographic proximity suitable for the connection, such as may be detected by one or more modules or engines of the point of sale device 102.

The point of sale device 102 may also include a memory 224. The memory 224 may be configured to store data for use by the point of sale device 102 in performing the functions discussed herein. The memory 224 may be configured to store data using suitable data formatting methods and schema and may be any suitable type of memory, such as read-only memory, random access memory, etc. The memory 224 may include, for example, encryption keys and algorithms, communication protocols and standards, data formatting standards and protocols, program code for modules and application programs of the processing device, and other data that may be suitable for use by the point of sale device 102 in the performance of the functions disclosed herein as will be apparent to persons having skill in the relevant art.

### Process for Registering Preselected, Customized Menu Options

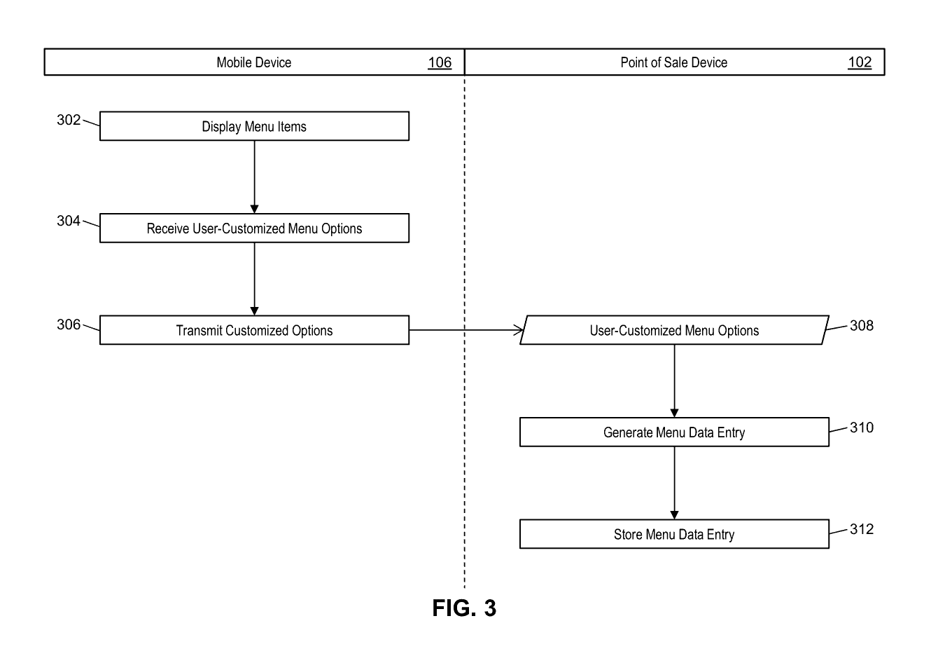

FIG. 3 illustrates a process for the registration of preselected, customized menu options with a point of sale device 102 via a mobile device 106.

In step 302, the mobile device 106 may display a plurality of menu items corresponding to a merchant to the consumer 104 as a user of the mobile device 106. In some embodiments, the mobile device 106 may execute an application program specifically configured to enable the registration of preselected, customized menu options, which may cause the display of the menu items to the consumer 104. In step 304, the consumer 104 may select a plurality of menu items to comprise one or more preselected, customized menu options that are customized for the consumer 104 using the mobile device 106. In some instances, the consumer 104 may also provide one or more descriptors for each preselected, customized menu option, such as a name that will be displayed on the point of sale device 102 for selection of the corresponding menu option.

In step 306, the mobile device 106 may electronically transmit a data signal to the point of sale device 102 that is superimposed with the preselected, customized menu options and corresponding data, which may include the associated menu items and descriptors. The data signal may be electronically transmitted via a suitable communication network, which may be different from the secure communication connection discussed above. For example, the mobile device 106 may electronically transmit the preselected, customized menu options to the point of sale device 102 via the Internet, for registration of the menu options prior to an ordering process. In some instances, the menu options may be transmitted to the point of sale device 102 via one or more third party entities. In other embodiments, the mobile device 106 may establish a secure communication connection with the point of sale device 102 prior to transmitting the menu options via the secure communication connection.

In step 308, the receiving device 202 of the point of sale device 102 may receive the data signal superimposed with the preselected, customized menu options and the associated menu items and/or descriptors. In step 310, the generation module 218 of the point of sale device 102 may generate one or more menu data entries 212 for storage in the menu database 210. Each menu data entry 212 may correspond to a preselected, customized menu option and include the data associated thereto. The generation module 218 may also generate a custom item identifier for each preselected, customized menu option, which may be stored in the corresponding menu data entry 212. The custom item identifier may be, for example, an identification number generated using an algorithm, a random number generator, a pseudo-random number generator, etc.

In some embodiments, each menu data entry 212 may also include a consumer identifier, which may be parsed from the data signal received from the mobile device 106. The consumer identifier may be associated with the mobile device 106 or the consumer 104, and may be used for the identification of all preselected, customized menu options (e.g., and associated menu data entries 212) associated with a consumer 104. In some instances, the generation module 218 may be configured to generate a single menu data entry 212 for each consumer 104 and/or mobile device 106, where the single menu data entry 212 may include the consumer identifier and all of the data associated with each of the preselected, customized menu options. In step 312, the querying module 214 of the point of sale device 102 may execute a query to insert the generated menu data entries 212 into the menu database 210.

### Process for Using Preselected, Customized Menu Options at a Point of Sale

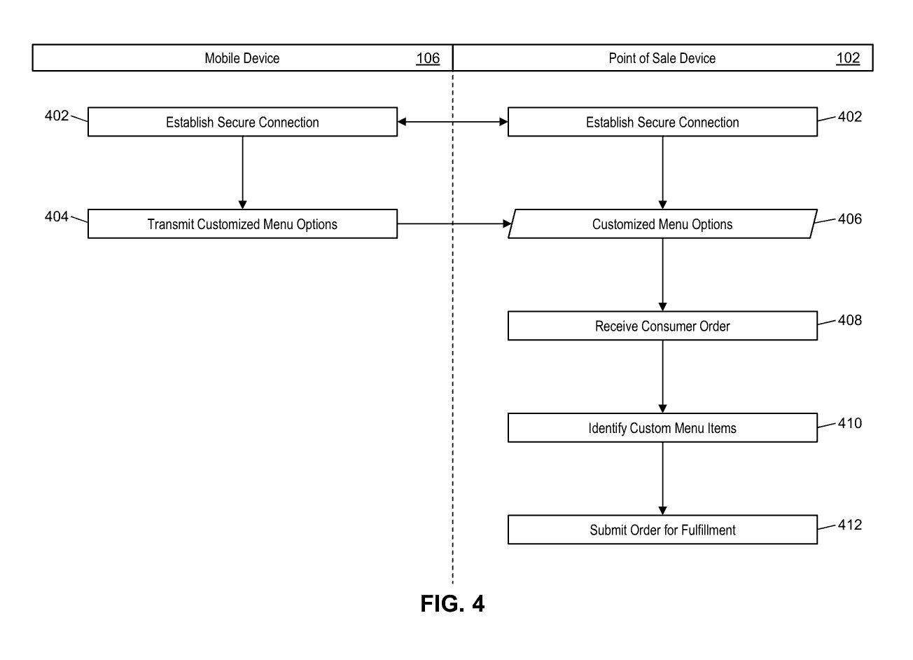

FIG. 4 illustrates a process for the use of preselected, customized menu options at a point of sale to place a customized order via a mobile device.

In step 402, the mobile device 106 and point of sale device 102 may establish a secure communication connection. In some embodiments, the secure communication connection may be established automatically upon detection of one of the devices by the other, such as when the mobile device 106 is within a predefined geographic proximity of the point of sale device 102. In other embodiments, the secure communication connection may be initiated, such as by the consumer 104 via the mobile device 106 or by a user of the point of sale device 102. The secure communication connection may utilize radio frequency, near field communication, Bluetooth, or any other suitable communication method and/or protocol.

In step 404, the mobile device 106 may electronically transmit a data signal to the point of sale device 102 using the secure communication connection that is superimposed with at least the custom item identifiers associated with each preselected, customized menu option registered by the consumer 104. In some instances, the data signal may also be superimposed with menu items and/or descriptors associated with each preselected, customized menu option, as well as a consumer identifier. In step 406, the receiving device 202 of the point of sale device 102 may receive and parse the data signal to obtain the data included therein.

In step 408, the point of sale device 102 may also receive the consumer's order. The consumer's order may be received via the receiving device 202 and/or one or more input devices of the point of sale device 102. For example, the consumer 104 may verbally communicate their order to an employee user of the point of sale device 102, who may then enter the order into the point of sale device 102 via a suitable input device, such as a keyboard, mouse, touch screen, click wheel, scroll wheel, camera, microphone, etc. In another example, the consumer 104 or employee may vocally announce their order via a microphone, which may electronically transmit the voice order for voice recognition by the point of sale device 102. The consumer's order may include at least one preselected, customized menu option, which may be indicated, for example, by use of a descriptor associated therewith and entered into the point of sale device 102 via a corresponding selection using an input device.

In step 410, the data identification module 216 of the point of sale device 102 may identify one or more menu items associated with each preselected, customized menu option included in the consumer's order. In one embodiment, the menu items may be identified in the data signal electronically transmitted by the mobile device 106 using the secure communication connection in step 404 and received by the receiving device 202 in step 406. In another embodiment, the querying module 214 may execute a query on the menu database 210 to identify a menu data entry 212 for each preselected, customized menu option using the associated custom item identifier. In yet another embodiment, the generation module 218 may generate a menu item request that includes the associated custom item identifier(s), which may be electronically transmitted to a third party data storage entity by the transmitting device 222 of the point of sale device. The receiving device 202 may receive a data signal from the third party data storage entity that includes the associated menu items.

Once the menu items corresponding to the preselected, customized menu options and any other menu items (e.g., traditional menu items indicated by the consumer 104) have been identified and entered into the point of sale device 104, then, in step 412, the completed order may be submitted for fulfillment. Submission of the order may include the generation of a submitted order 208 by the generation module 218 and adding thereof to the order database 206 via a query by the querying module 214.

### Exemplary Method for Submitting Preselected, Customized Data Exchanged Between a Mobile Device and a Point of Sale

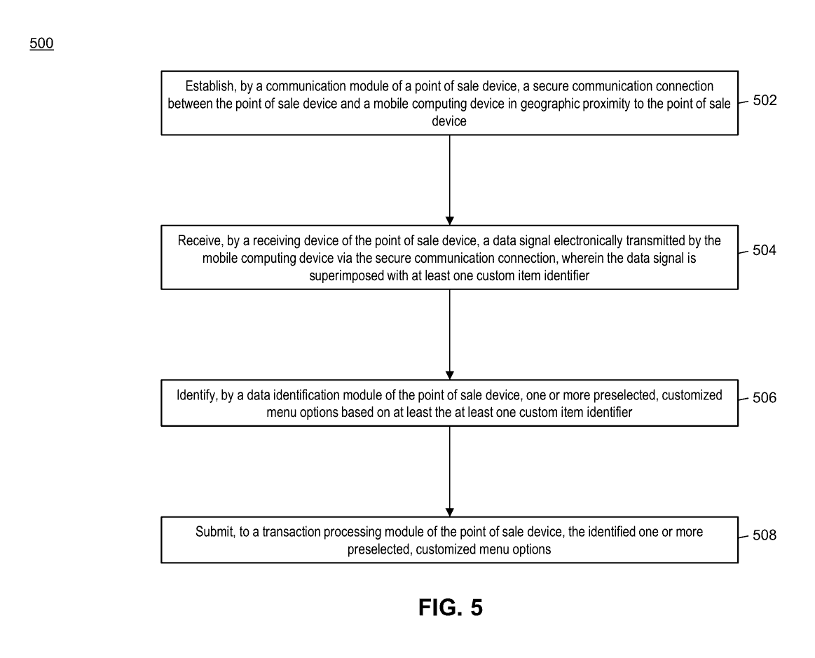

FIG. 5 illustrates a method 500 for the submission of preselected customized data pertaining to customized menu options at a merchant to a point of sale of the merchant via a secure communication connection with a mobile device.

In step 502, a secure communication connection may be established by a communication module (e.g., the communication module 204) of a point of sale device (e.g., the point of sale device 102) between the point of sale device and a mobile computing device (e.g., the mobile device 106) in geographic proximity to the point of sale device. In step 504, a data signal electronically transmitted by the mobile computing device via the secure communication connection may be received by a receiving device (e.g., the receiving device 220) of the point of sale device, wherein the data signal is superimposed with at least one custom item identifier.

In step 506, one or more preselected, customized menu options may be identified by a data identification module (e.g., the data identification module 216) of the point of sale device based on at least the at least one custom item identifier. In step 508, the identified one or more preselected, customized menu options may be submitted to an order processing module (e.g., the order processing module 220) of the point of sale device.

In one embodiment, the one or more preselected, customized menu options may be identified in the received data signal. In some embodiments, the method 500 may also include storing, in a menu database (e.g., the menu database 210) of the point of sale device, a plurality of menu data entries (e.g., menu data entries 212), wherein each menu data entry is a structured data set related to a customized menu selection and includes at least a specific custom item identifier and one or more item options, wherein identifying the one or more preselected, customized menu options includes executing, by a querying module (e.g., the querying module 214) of the point of sale device, a query on the menu database to identify one or more specific menu data entries where the included specific custom item identifier corresponds to one of the at least one custom item identifiers, and the identified one or more preselected, customized menu options correspond to the one or more item options included in the identified one or more specific menu data entries.

In one embodiment, identifying the one or more preselected, customized menu options may comprises: electronically transmitting, by a transmitting device (e.g., the transmitting device 222) of the point of sale device, a data signal to an external computing device superimposed with at least the at least one custom item identifier; and receiving, by the receiving device of the point of sale device, an additional data signal from the external computing device superimposed with at least the one or more preselected, customized menu options. In some embodiments, the received data signal may originate from an application programmed executed by the mobile computing device configured to receive user selection of the at least one custom item identifier. In one embodiment, the secure communication connection may utilize at least one of: radio frequency, near field communication, and Bluetooth.

In some embodiments, the method 500 may further include receiving, by the receiving device of the point of sale device, one or more additional custom item identifiers and, for each additional custom item identifier, one or more associated customized menu options. In a further embodiment, the one or more additional custom item identifiers and one or more associated customized menu options may be superimposed in the received data signal. In another further embodiment, the method 500 may even further include electronically transmitting, by the transmitting device of the point of sale device, at least the one or more associated customized menu options for each additional custom item identifier and the identified preselected, customized menu options to a display device for display to a user of the mobile computing device. In yet another further embodiment, the one or more additional custom item identifiers may be superimposed in an additional data signal received prior to receipt of the data signal superimposed with the at least one custom item identifier.

### Payment Transaction Processing System and Process

FIG. 6 illustrates a transaction processing system and a process 600 for the processing of payment transactions in the system. The process 600 and steps included therein may be performed by one or more components of the system 100 discussed above, such as the point of sale device 102, mobile device 106, and payment network 110, etc. The processing of payment transactions using the system and process 600 illustrated in FIG. 6 and discussed below may utilize the payment rails, which may be comprised of the computing devices and infrastructure utilized to perform the steps of the process 600 as specially configured and programmed by the entities discussed below, including the transaction processing server 612, which may be associated with one or more payment networks configured to processing payment transactions. It will be apparent to persons having skill in the relevant art that the process 600 may be incorporated into the processes illustrated in FIGS. 3-5, discussed above, with respect to the step or steps involved in the processing of a payment transaction. In addition, the entities discussed herein for performing the process 600 may include one or more computing devices or systems configured to perform the functions discussed below. For instance, the merchant 606 may be comprised of one or more point of sale devices, a local communication network, a computing server, and other devices configured to perform the functions discussed below.

In step 620, an issuing financial institution 602 may issue a payment card or other suitable payment instrument to a consumer 604. The issuing financial institution may be a financial institution, such as a bank, or other suitable type of entity that administers and manages payment accounts and/or payment instruments for use with payment accounts that can be used to fund payment transactions. The consumer 604 may have a transaction account with the issuing financial institution 602 for which the issued payment card is associated, such that, when used in a payment transaction, the payment transaction is funded by the associated transaction account. In some embodiments, the payment card may be issued to the consumer 604 physically. In other embodiments, the payment card may be a virtual payment card or otherwise provisioned to the consumer 604 in an electronic format.

In step 622, the consumer 604 may present the issued payment card to a merchant 606 for use in funding a payment transaction. The merchant 606 may be a business, another consumer, or any entity that may engage in a payment transaction with the consumer 604. The payment card may be presented by the consumer 604 via providing the physical card to the merchant 606, electronically transmitting (e.g., via near field communication, wireless transmission, or other suitable electronic transmission type and protocol) payment details for the payment card, or initiating transmission of payment details to the merchant 606 via a third party. The merchant 606 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 624, the merchant 606 may enter transaction details into a point of sale computing system. The transaction details may include the payment details provided by the consumer 604 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 606 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 606 may be an online retailer in an e-commerce transaction. In such embodiments, the transaction details may be entered in a shopping cart or other repository for storing transaction data in an electronic transaction as will be apparent to persons having skill in the relevant art.

In step 626, the merchant 606 may electronically transmit a data signal superimposed with transaction data to a gateway processor 608. The gateway processor 608 may be an entity configured to receive transaction details from a merchant 606 for formatting and transmission to an acquiring financial institution 610. In some instances, a gateway processor 608 may be associated with a plurality of merchants 606 and a plurality of acquiring financial institutions 610. In such instances, the gateway processor 608 may receive transaction details for a plurality of different transactions involving various merchants, which may be forwarded on to appropriate acquiring financial institutions 610. By having relationships with multiple acquiring financial institutions 610 and having the requisite infrastructure to communicate with financial institutions using the payment rails, such as using application programming interfaces associated with the gateway processor 608 or financial institutions used for the submission, receipt, and retrieval of data, a gateway processor 608 may act as an intermediary for a merchant 606 to be able to conduct payment transactions via a single communication channel and format with the gateway processor 608, without having to maintain relationships with multiple acquiring financial institutions 610 and payment processors and the hardware associated thereto. Acquiring financial institutions 610 may be financial institutions, such as banks, or other entities that administers and manages payment accounts and/or payment instruments for use with payment accounts. In some instances, acquiring financial institutions 610 may manage transaction accounts for merchants 606. In some cases, a single financial institution may operate as both an issuing financial institution 602 and an acquiring financial institution 610.

The data signal transmitted from the merchant 606 to the gateway processor 608 may be superimposed with the transaction details for the payment transaction, which may be formatted based on one or more standards. In some embodiments, the standards may be set forth by the gateway processor 608, which may use a unique, proprietary format for the transmission of transaction data to/from the gateway processor 608. In other embodiments, a public standard may be used, such as the International Organization for Standardization's ISO 8683 standard. The standard may indicate the types of data that may be included, the formatting of the data, how the data is to be stored and transmitted, and other criteria for the transmission of the transaction data to the gateway processor 608.

In step 628, the gateway processor 608 may parse the transaction data signal to obtain the transaction data superimposed thereon and may format the transaction data as necessary. The formatting of the transaction data may be performed by the gateway processor 608 based on the proprietary standards of the gateway processor 608 or an acquiring financial institution 610 associated with the payment transaction. The proprietary standards may specify the type of data included in the transaction data and the format for storage and transmission of the data. The acquiring financial institution 610 may be identified by the gateway processor 608 using the transaction data, such as by parsing the transaction data (e.g., deconstructing into data elements) to obtain an account identifier included therein associated with the acquiring financial institution 610. In some instances, the gateway processor 608 may then format the transaction data based on the identified acquiring financial institution 610, such as to comply with standards of formatting specified by the acquiring financial institution 610. In some embodiments, the identified acquiring financial institution 610 may be associated with the merchant 606 involved in the payment transaction, and, in some cases, may manage a transaction account associated with the merchant 606.

In step 630, the gateway processor 608 may electronically transmit a data signal superimposed with the formatted transaction data to the identified acquiring financial institution 610. The acquiring financial institution 610 may receive the data signal and parse the signal to obtain the formatted transaction data superimposed thereon. In step 632, the acquiring financial institution may generate an authorization request for the payment transaction based on the formatted transaction data. The authorization request may be a specially formatted transaction message that is formatted pursuant to one or more standards, such as the ISO 8683 standard and standards set forth by a payment processor used to process the payment transaction, such as a payment network. The authorization request may be a transaction message that includes a message type indicator indicative of an authorization request, which may indicate that the merchant 606 involved in the payment transaction is requesting payment or a promise of payment from the issuing financial institution 602 for the transaction. The authorization request may include a plurality of data elements, each data element being configured to store data as set forth in the associated standards, such as for storing an account number, application cryptogram, transaction amount, issuing financial institution 602 information, etc.

In step 634, the acquiring financial institution 610 may electronically transmit the authorization request to a transaction processing server 612 for processing. The transaction processing server 612 may be comprised of one or more computing devices as part of a payment network configured to process payment transactions. In some embodiments, the authorization request may be transmitted by a transaction processor at the acquiring financial institution 610 or other entity associated with the acquiring financial institution. The transaction processor may be one or more computing devices that include a plurality of communication channels for communication with the transaction processing server 612 for the transmission of transaction messages and other data to and from the transaction processing server 612. In some embodiments, the payment network associated with the transaction processing server 612 may own or operate each transaction processor such that the payment network may maintain control over the communication of transaction messages to and from the transaction processing server 612 for network and informational security.

In step 636, the transaction processing server 612 may perform value-added services for the payment transaction. Value-added services may be services specified by the issuing financial institution 602 that may provide additional value to the issuing financial institution 602 or the consumer 604 in the processing of payment transactions. Value-added services may include, for example, fraud scoring, transaction or account controls, account number mapping, offer redemption, loyalty processing, etc. For instance, when the transaction processing server 612 receives the transaction, a fraud score for the transaction may be calculated based on the data included therein and one or more fraud scoring algorithms and/or engines. In some instances, the transaction processing server 612 may first identify the issuing financial institution 602 associated with the transaction, and then identify any services indicated by the issuing financial institution 602 to be performed. The issuing financial institution 602 may be identified, for example, by data included in a specific data element included in the authorization request, such as an issuer identification number. In another example, the issuing financial institution 602 may be identified by the primary account number stored in the authorization request, such as by using a portion of the primary account number (e.g., a bank identification number) for identification.

In step 638, the transaction processing server 612 may electronically transmit the authorization request to the issuing financial institution 602. In some instances, the authorization request may be modified, or additional data included in or transmitted accompanying the authorization request as a result of the performance of value-added services by the transaction processing server 612. In some embodiments, the authorization request may be transmitted to a transaction processor (e.g., owned or operated by the transaction processing server 612) situated at the issuing financial institution 602 or an entity associated thereof, which may forward the authorization request to the issuing financial institution 602.

In step 640, the issuing financial institution 602 may authorize the transaction account for payment of the payment transaction. The authorization may be based on an available credit amount for the transaction account and the transaction amount for the payment transaction, fraud scores provided by the transaction processing server 612, and other considerations that will be apparent to persons having skill in the relevant art. The issuing financial institution 602 may modify the authorization request to include a response code indicating approval (e.g., or denial if the transaction is to be denied) of the payment transaction. The issuing financial institution 602 may also modify a message type indicator for the transaction message to indicate that the transaction message is changed to be an authorization response. In step 642, the issuing financial institution 602 may transmit (e.g., via a transaction processor) the authorization response to the transaction processing server 612.

In step 644, the transaction processing server 612 may forward the authorization response to the acquiring financial institution 610 (e.g., via a transaction processor). In step 646, the acquiring financial institution may generate a response message indicating approval or denial of the payment transaction as indicated in the response code of the authorization response, and may transmit the response message to the gateway processor 608 using the standards and protocols set forth by the gateway processor 608. In step 648, the gateway processor 608 may forward the response message to the merchant 606 using the appropriate standards and protocols. In step 660, the merchant 606 may then provide the products purchased by the consumer 604 as part of the payment transaction to the consumer 604.

In some embodiments, once the process 600 has completed, payment from the issuing financial institution 602 to the acquiring financial institution 610 may be performed. In some instances, the payment may be made immediately or within one business day. In other instances, the payment may be made after a period of time, and in response to the submission of a clearing request from the acquiring financial institution 610 to the issuing financial institution 602 via the transaction processing server 602. In such instances, clearing requests for multiple payment transactions may be aggregated into a single clearing request, which may be used by the transaction processing server 612 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 640), the transaction processing server 612 may be configured to perform authorization of transactions on behalf of the issuing financial institution 602. Such actions may be referred to as “stand-in processing,” where the transaction processing server “stands in” as the issuing financial institution 602. In such instances, the transaction processing server 612 may utilize rules set forth by the issuing financial institution 602 to determine approval or denial of the payment transaction, and may modify the transaction message accordingly prior to forwarding to the acquiring financial institution 610 in step 644. The transaction processing server 612 may retain data associated with transactions for which the transaction processing server 612 stands in, and may transmit the retained data to the issuing financial institution 602 once communication is reestablished. The issuing financial institution 602 may then process transaction accounts accordingly to accommodate for the time of lost communication.

In another example, if the transaction processing server 612 is unavailable for submission of the authorization request by the acquiring financial institution 610, then the transaction processor at the acquiring financial institution 610 may be configured to perform the processing of the transaction processing server 612 and the issuing financial institution 602. The transaction processor may include rules and data suitable for use in making a determination of approval or denial of the payment transaction based on the data included therein. For instance, the issuing financial institution 602 and/or transaction processing server 612 may set limits on transaction type, transaction amount, etc. that may be stored in the transaction processor and used to determine approval or denial of a payment transaction based thereon. In such instances, the acquiring financial institution 610 may receive an authorization response for the payment transaction even if the transaction processing server 612 is unavailable, ensuring that transactions are processed and no downtime is experienced even in instances where communication is unavailable. In such cases, the transaction processor may store transaction details for the payment transactions, which may be transmitted to the transaction processing server 612 (e.g., and from there to the associated issuing financial institutions 602) once communication is reestablished.

In some embodiments, transaction processors may be configured to include a plurality of different communication channels, which may utilize multiple communication cards and/or devices, to communicate with the transaction processing server 612 for the sending and receiving of transaction messages. For example, a transaction processor may be comprised of multiple computing devices, each having multiple communication ports that are connected to the transaction processing server 612. In such embodiments, the transaction processor may cycle through the communication channels when transmitting transaction messages to the transaction processing server 612, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 610 may identify that an authorization request involves an issuing financial institution 602 (e.g., via the bank identification number included in the transaction message) for which no value-added services are required. The transaction processor at the acquiring financial institution 610 may then transmit the authorization request directly to the transaction processor at the issuing financial institution 602 (e.g., without the authorization request passing through the transaction processing server 612), where the issuing financial institution 602 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 612 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 608, acquiring financial institution 610, etc.) for processing using this advanced network, and to quickly and efficiently receive a response regarding the ability for a consumer 604 to fund the payment transaction.

### Computer System Architecture

FIG. 7 illustrates a computer system 700 in which embodiments of the present disclosure, or portions thereof, may be implemented as computer-readable code. For example, the point of sale device of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device specifically configured to perform the functions discussed herein. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3-6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

The processor device 704 may comprise one or more modules or engines configured to perform the functions of the computer system 700. Each of the modules or engines may be implemented using hardware and, in some instances, may also utilize software, such as corresponding to program code and/or programs stored in the main memory 708 or secondary memory 710. In such instances, program code may be compiled by the processor device 704 (e.g., by a compiling module or engine) prior to execution by the hardware of the computer system 700. For example, the program code may be source code written in a programming language that is translated into a lower level language, such as assembly language or machine code, for execution by the processor device 704 and/or any additional hardware components of the computer system 700. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 700 to perform the functions disclosed herein. It will be apparent to persons having skill in the relevant art that such processes result in the computer system 700 being a specially configured computer system 700 uniquely programmed to perform the functions discussed above.

Techniques consistent with the present disclosure provide, among other features, systems and methods for submitting preselected, customized data exchanged between a mobile device and a point of sale. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for submitting preselected, customized data exchanged between a mobile device and a point of sale, comprising:
establishing, by a communication module of a point of sale device, a communication connection between the point of sale device and a mobile computing device in geographic proximity to the point of sale device;
receiving, by a receiving device of the point of sale device, a data signal electronically transmitted by the mobile computing device via the communication connection, wherein the data signal is superimposed with at least one custom item identifier;
identifying, by a data identification module of the point of sale device, one or more preselected, customized menu options based on at least the at least one custom item identifier; and
submitting, to an order processing module of the point of sale device, the identified one or more preselected, customized menu options.

2. The method of claim 1, wherein the one or more preselected, customized menu options are identified in the received data signal.

3. The method of claim 1, further comprising:
storing, in a menu database of the point of sale device, a plurality of menu data entries, wherein each menu data entry is a structured data set related to a customized menu selection and includes at least a specific custom item identifier and one or more item options, wherein
identifying the one or more preselected, customized menu options includes executing, by a querying module of the point of sale device, a query on the menu database to identify one or more specific menu data entries where the included specific custom item identifier corresponds to one of the at least one custom item identifiers, and
the identified one or more preselected, customized menu options correspond to the one or more item options included in the identified one or more specific menu data entries.

4. The method of claim 1, wherein identifying the one or more preselected, customized menu options comprises:
electronically transmitting, by a transmitting device of the point of sale device, a data signal to an external computing device superimposed with at least the at least one custom item identifier; and
receiving, by the receiving device of the point of sale device, an additional data signal from the external computing device superimposed with at least the one or more preselected, customized menu options.

5. The method of claim 1, wherein the received data signal originates from an application programmed executed by the mobile computing device configured to receive user selection of the at least one custom item identifier.

6. The method of claim 1, wherein the communication connection utilizes at least one of: radio frequency, near field communication, and Bluetooth.

7. The method of claim 1, further comprising:
receiving, by the receiving device of the point of sale device, one or more additional custom item identifiers and, for each additional custom item identifier, one or more associated customized menu options.

8. The method of claim 7, wherein the one or more additional custom item identifiers and one or more associated customized menu options are superimposed in the received data signal.

9. The method of claim 7, further comprising:
electronically transmitting, by a transmitting device of the point of sale device, at least the one or more associated customized menu options for each additional custom item identifier and the identified preselected, customized menu options to a display device for display to a user of the mobile computing device.

10. The method of claim 7, wherein the one or more additional custom item identifiers are superimposed in an additional data signal received prior to receipt of the data signal superimposed with the at least one custom item identifier.

11. A system for submitting preselected, customized data exchanged between a mobile device and a point of sale, comprising:
a communication module of a point of sale device configured to establish a communication connection between the point of sale device and a mobile computing device in geographic proximity to the point of sale device;
a receiving device of the point of sale device configured to receive a data signal electronically transmitted by the mobile computing device via the communication connection, wherein the data signal is superimposed with at least one custom item identifier;
a data identification module of the point of sale device configured to identify one or more preselected, customized menu options based on at least the at least one custom item identifier; and
an order processing module of the point of sale device configured to receive a submission of the identified one or more preselected, customized menu options.

12. The system of claim 11, wherein the one or more preselected, customized menu options are identified in the received data signal.

13. The system of claim 11, further comprising:
a menu database of the point of sale device configured to store a plurality of menu data entries, wherein each menu data entry is a structured data set related to a customized menu selection and includes at least a specific custom item identifier and one or more item options, wherein
identifying the one or more preselected, customized menu options includes executing, by a querying module of the point of sale device, a query on the menu database to identify one or more specific menu data entries where the included specific custom item identifier corresponds to one of the at least one custom item identifiers, and
the identified one or more preselected, customized menu options correspond to the one or more item options included in the identified one or more specific menu data entries.

14. The system of claim 11, wherein identifying the one or more preselected, customized menu options comprises:
electronically transmitting, by a transmitting device of the point of sale device, a data signal to an external computing device superimposed with at least the at least one custom item identifier; and
receiving, by the receiving device of the point of sale device, an additional data signal from the external computing device superimposed with at least the one or more preselected, customized menu options.

15. The system of claim 11, wherein the received data signal originates from an application programmed executed by the mobile computing device configured to receive user selection of the at least one custom item identifier.

16. The system of claim 11, wherein the communication connection utilizes at least one of: radio frequency, near field communication, and Bluetooth.

17. The system of claim 11, wherein the receiving device of the point of sale device is further configured to receive one or more additional custom item identifiers and, for each additional custom item identifier, one or more associated customized menu options.

18. The system of claim 17, wherein the one or more additional custom item identifiers and one or more associated customized menu options are superimposed in the received data signal.

19. The system of claim 17, further comprising:
a transmitting device of the point of sale device configured to electronically transmit at least the one or more associated customized menu options for each additional custom item identifier and the identified preselected, customized menu options to a display device for display to a user of the mobile computing device.

20. The system of claim 17, wherein the one or more additional custom item identifiers are superimposed in an additional data signal received prior to receipt of the data signal superimposed with the at least one custom item identifier.
